(19) United States
(12) Patent Application Publication
(10) Pub. No.: US 2015/0169527 A1
(43) Pub. Date: Jun. 18, 2015

(54) INTERACTING METHOD, APPARATUS AND SERVER BASED ON IMAGE

(71) Applicant: TENCENT TECHNOLOGY (SHENZHEN) COMPANY LIMITED, Shenzhen (CN)

(72) Inventors: Zhihao Zheng, Shenzhen (CN); Zhu Liang, Shenzhen (CN); Huixing Wang, Shenzhen (CN); Jia Ma, Shenzhen (CN); Hao Wu, Shenzhen (CN); Huiming Gan, Shenzhen (CN); Yiting Zhou, Shenzhen (CN); Zhen Liu, Shenzhen (CN); Hao Zhang, Shenzhen (CN); Bo Chen, Shenzhen (CN); Feng Rao, Shenzhen (CN); Hailong Liu, Shenzhen (CN); Ganxiong Lin, Shenzhen (CN)

(73) Assignee: TENCENT TECHNOOGY (SHENZHEN) COMPANY LIMITED, Shenzhen (CN)

(21) Appl. No.: 14/410,875

(22) PCT Filed: Jun. 26, 2013
(86) PCT No.: PCT/CN2013/077999

§ 371 Date: Dec. 23, 2014

(30) Foreign Application Priority Data
Jun. 28, 2012 (CN) 201210216274.5

(51) Int. Cl. G06F 17/24; G06K 9/00

(52) U.S. Cl. CPC G06F 17/241; G06K 9/00228

(57) ABSTRACT

An interactive method, apparatus based on an image and a server are provided according to embodiments of the present invention. The method includes: recognizing a face region in an image; generating a face box corresponding to the face region; generating a label box corresponding to the face box; and representing label information corresponding to the face region in the label box by performing one of the following modes: obtaining the label information corresponding to the face region from a server, representing the label information obtained from the server in the label box; and receiving the label information corresponding to the face region inputted by a user, representing the label information inputted by the user in the label box. Thus, based on the label information provided by the server or the user, information associated with a circled region is customized (e.g., reviews information), and is further pushed to an associated friend. Thus, interaction between a user pushing the face region and the associated friend is improved.

### FIELD OF THE INVENTION

The present invention relates to an internet application technology field, and more particularly, to an interaction method, apparatus and server based on an image.

### BACKGROUND OF THE INVENTION

With development of a computer technology and a network technology, an internet technology and an instant messaging technology play an important role in daily life, study and work. Furthermore, with development of an internet, instant messaging in the internet is developed to a mobile direction.

In various internet applications, there are some applications of “circle a person”. The applications of “circle a person” are used in applications including image content (e.g., social applications, image management applications). In the applications of “circle a person”, a behavior of the circled person in an image is displayed for the circled person or friends of the circled person by detecting and circling a location of a person. When an operation of “circle a person” is performed through a touch device, a user can operate the application by contacting a touch screen. In particular, in the applications of “circle a person”, in an image, a user can mark a face region, can mark name information of a user associated with the face region, and can push the face region and the name information of the user associated with the face region to an associated friend. Furthermore, the user can provide a link about the user corresponding to the face region so that other information of the user corresponding to the face region can be searched for by clicking the link.

In current various applications of “circle a person”, for the face region, the user have to mark name information of the user associated with the face region, and pushes name information to an associated friend. Thus, the user cannot perform a user-defined operation for defining information associated with the face region, and obviously, cannot push the user-defined information associated with the face region to the associated friend. The associated friend cannot obtain the global and abundant information defined by the user about the face region. Furthermore, since the associated friend cannot obtain the information about the face region defined by the user of the face region, interaction between the user pushing the image and the associated friend will be impacted.

Furthermore, a way for displaying the name information of the user associated with the face region is single. Thus, the displaying way cannot be adjusted according to user requirements, and the face region automatically recognized cannot be manually adjusted, operation will be tedious.

### SUMMARY OF THE INVENTION

An interaction method based on an image is provided according to embodiment of the present invention to improve interactive success rate.

An interaction apparatus based on an image is provided according to embodiment of the present invention to improve interactive success rate.

A server is provided according to embodiment of the present invention to improve interactive success rate.

An interactive method based on an image includes:
recognizing a face region in an image;
generating a face box corresponding to the face region;
generating a label box corresponding to face box; and
representing label information associated with the face region in the label box by performing one of the following modes: obtaining the label information associated with the face region from a server, representing the label information obtained from the server in the label box; and
receiving the label information associated with the face region inputted by a user, representing the label information inputted by the user in the label box.

An interactive apparatus based on an image includes:
a face region recognition module, to recognize a face region in an image;
a face box generation module, to generate a face box corresponding to the face region;
a label information processing module, to generate a label box corresponding to face box; represent label information associated with the face region in the label box by performing one of the following modes:
obtaining the label information associated with the face region from a server, representing the label information obtained from the server in the label box; and receiving the label information associated with the face region inputted by a user, representing the label information inputted by the user in the label box.

A server includes:
a label information storage module, to store pre-configured label information;
a label information transmitting module, to transmit label information associated with a face region to a client so that the client represents the label information in a label box, wherein the face region is recognized from an image by the client, the label box is associated with the label box in the face region.

It can be seen from the above that, in an embodiment of the present invention, a face region is recognized in an image, a face box is generated corresponding to the face region, a label box corresponding to face box is generated; and label information associated with the face region is represented in the label box by performing one of the following modes: obtaining the label information associated with the face region from a server, representing the label information obtained from the server in the label box; and receiving the label information associated with the face region inputted by a user, representing the label information inputted by the user in the label box. Thus, after applying the technology solution according to the present invention, the label information can be represented in the label box based on label information transmitted from the server or user-defined label information inputted by the user, which is not limited only to represent a name. Information associated with a circled region (e.g., reviews information) can be defined by users, and can be further pushed to an associated friend. Thus, interaction between a user pushing the face region and the associated friend will be improved.

### BRIEF DESCRIPTION OF DRAWINGS

FIG. 1 is a flowchart illustrating an interactive method based on an image according to an embodiment of the present invention;

FIG. 2 is a schematic diagram illustrating a way of selecting a face region according to an embodiment of the present invention;

FIG. 3 is a schematic diagram illustrating a way of generating label information according to an embodiment of the present invention;

FIG. 4 is a flowchart illustrating a method for performing an application of “circle a person” based on an image according to an embodiment of the present invention;

FIG. 5A is a first schematic diagram illustrating a structure of an apparatus for performing an application of “circle a person” based on an image according to an embodiment of the present invention;

FIG. 5B is a second schematic diagram illustrating a structure of an apparatus for performing an application of “circle a person” based on an image according to an embodiment of the present invention;

FIG. 6 is a schematic diagram illustrating a structure of a server according to an embodiment of the present invention;

FIG. 7 is a first schematic diagram illustrating a way of displaying label information according to an embodiment of the present invention;

FIG. 8 is a second schematic diagram illustrating a way of displaying label information according to an embodiment of the present invention.

### DETAILED DESCRIPTION OF THE INVENTION

In order to make the object, technical solution and merits of the present invention clearer, the present invention will be illustrated in detail hereinafter with reference to the accompanying drawings and specific embodiments.

According to embodiments of the present invention, a face region of a user in an image may be associated with a friend in a relationship link or a non-friend. Furthermore, by combining a face detection technology, a customized face box is added so as to reduce operations as much as possible.

For an application of “circle a person”, a user may detect and mark a face region in an image, and may push information related with the face region to an association user in a relationship link of the user. In particular, in an application of “circle a person” according to an embodiment of the present invention, a friend may be selected from the relationship link, and label information transmitted from a server is pushed to the friend. Furthermore, customized label information inputted by the user may be selected by the user, and the customized label information inputted by the user is pushed to the friend.

In an example, the label information transmitted by the server may be interesting label information pre-configured by the server. The label information may be displayed in a label box generated through label box background information dynamically configured by the server to make label displaying ways plentiful.

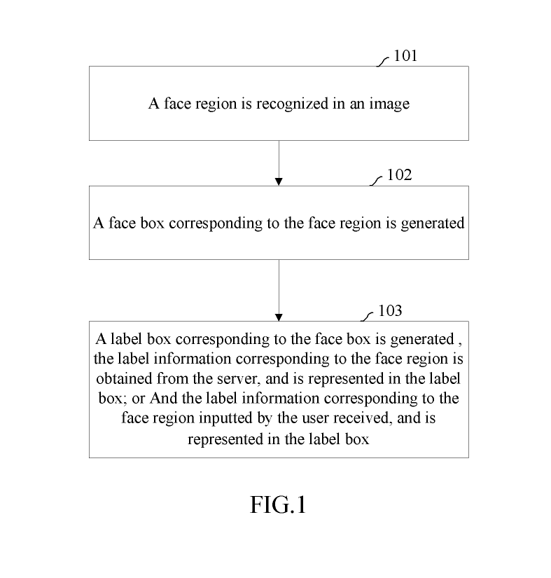

FIG. 1 is a flowchart illustrating an interactive method based on an image according to an embodiment of the present invention.

As shown in FIG. 1, the method includes procedures as follows.

At block 101, a client recognizes a face region in an image.

The face region recognized by the user in the image may be received. Alternatively, a machine may automatically recognize the face region in the image through applying a face recognition algorithm.

In an example, the face recognition algorithm may be adopted to automatically recognize the face region.

The face recognition may be a computer technology of performing identity authentication by analyzing and comparing face visual feature information. A face recognition system may include image capture, face detection, image pre-processing, and face recognition (identification or identity search) etc.

The face recognition algorithm may include classifications as follows: an identification algorithm based on face feature points, an identification algorithm based on an entire face image, an identification algorithm based on a template, an identification algorithm based on a neural network etc. In an example, the face recognition algorithm applying to the embodiment of the present invention may include a Principal Component Analysis (PCA) algorithm, an Independent Component Analysis (ICA) algorithm, an Isometric Feature Mapping (ISOMAP) algorithm, a Kernel Principal Components Analysis (KPCA) algorithm, a Linear Principal Component Analysis (LPCA) algorithm etc.

It can be seen by those skilled in the art that, algorithms above are exemplary examples. The present invention is not limited to the exemplary examples above.

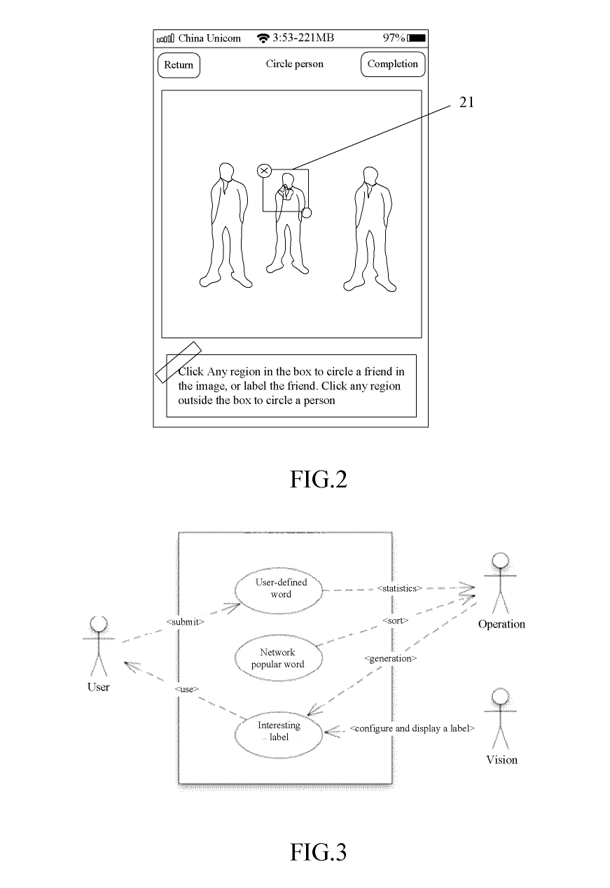

FIG. 2 is a schematic diagram illustrating a way of selecting a face region according to an embodiment of the present invention. A user may recognize a face region in an image, or a machine may automatically recognize the face region through applying a face recognition algorithm. In FIG. 2, a box framing a face 21 is represented, which may be named as a face box. A process of generating the face box is described at block 102.

At block 102, the client generates a face box corresponding to the face region.

When the face region is automatically recognized in the image by the machine through the face recognition algorithm, by adopting a face detection technology, face detection is performed for an inputted image through a face detection database stored in the local client or a network side. Location information of the face in the image is inputted. The information may be initially displayed on the image in a box manner so as to be adjusted by the user. The face box is generated according to the location information determined through a way that the user drags the face box in the image.

When the user recognizes the face region in the image, the face box is generated according to the location information determined through a way that the user drags the face box in the image.

The user may perform an edit operation for the face box. The user may adopt any one of the following edit operations to perform an edit operation for the face box.

The face box is dragged. In an example, by a touch screen, the user may contact any location on the face box except a vertex in a lower right corner, may move a contact point so that the face box may move with moving of the contact point. When the face box is moved to a suitable location, the contact is interrupted.

The face box is zoomed. In an example, through a touch screen, the user may contact a location on the vertex in the lower right corner, may move a contact point so that a size of the face box may be changed with moving of the contact point, and when a suitable size of the face box is obtained, the contact is interrupted.

The face box is deleted. In an example, through a touch screen, the user may continually touch any location in the face box until a deletion node arises, and may click the deletion node.

The edit operations above may be performed through operating a pointing device. The pointing device may be an inputting device. In particular, the pointing device may be an interface device. The pointing device may allow the user to input space (continuous or multidimensional) data into a computer. A mouse is a common pointing device. Moving the pointing device may be represented through moving a pointer, a cursor or another substitute on a screen of a computing device. The pointing device may control the moving of the pointer, the cursor or another substitute on a screen of the computing device.

In an example, when multiple face boxes are generated, a location of each face box may be further limited so that the face boxes may not be overlapped, and each face box may be ensured to be in an image displaying area.

At block 103, the client generates a label box corresponding to the face box, and represents label information corresponding to the face region through any one of ways as follows: obtaining the label information corresponding to the face region from the server, representing the label information obtained from the server in the label box; and receiving the label information corresponding to the face region inputted by the user, representing the label box inputted by the user in the label box.

After the face box is generated, the label box corresponding to the face box is generated, which is used to displaying the label information.

In an example, label box background information may be provided by a server at a network side for the client. The client may generate the label box according to the label box background information. Thus, the server may provide label boxes with various representing manners for users by adjusting the label box background information at the background. For example, the label box background information provided by the server may include a shape of the label box, a label box displaying manner, and/or a color of the label box etc.

In an example, according to hobby of the user, the label box may be generated by the user in local. For example, the user may in local pre-configure the size of the label box, the label box displaying manner, and/or the color of the label box. Afterwards, the client may automatically generate the label box based on the size of the label box, the label box displaying manner, and/or the color of the label box.

In an example, the client obtains the label information corresponding to the face box from the server, and displays the label information in the generated label box. In an example, the label information corresponding to the face box may be reviews information of the face box. For example, a face recognized from the face box is a face of a person naming “San Zhang”, the label information may be direct reviews information such as “handsome boy”, or may be indirect reviews information such as “the three year old winner”.

FIG. 3 is a schematic diagram illustrating a way of generating label information according to an embodiment of the present invention.

The server may pre-store a group of pre-configured candidate words of the label information (e.g., current network hot keywords, customized word provided by users) to be included in a label information list. The server may transmit the label information list to the client of the user. The user may select at least one suitable candidate word of the label information from the label information list as the label information, and may display the at least one suitable candidate word in the label box. In an example, the candidate words of the label information in the label information list may be editable.

In an example, a process of generating and transmitting the label information list includes: calculating, by the server, frequency of using at least one candidate word of the label information, ranking the at least one candidate word of the label information based on the frequency of using the at least one candidate word from biggest to smallest, generating the label information list according to a ranking result, wherein the label information list includes the at least one candidate word, wherein the number of the at least one candidate word is predetermined, transmitting the label information list to the client. The client obtains the at least one candidate word from the label information list, selects at least one candidate word corresponding to the face region from the at least one candidate word, and displaying the at least one candidate word associated with the face region in the label box.

In an example, the user may directly edit customized label information in the label box in the client. The customized label information may include review information related with the recognized face region, or may include review information representing user mood etc.

When the label information is provided to the client by the server, the server running on a background may generate the label information by collecting a condition of using at least one customized candidate word and sorting at least one word widely used in the network. In an example, the label information may include interesting label information. The server running on a background may generate the interesting label information by collecting a condition of using the at least one customized candidate word and sorting the at least one word widely used in the network. Furthermore, a label displaying way, e.g., content such as a color, may be automatically configured according to visual design to make the representation more vivid.

In an example, the label box may be edited by adopting at least one editing operation as follows.

A color of the label box is adjusted. In an example, by a touch screen, the user clicks one of colors in a pre-configured color set, thus, a color of the face box is changed with the clicked color.

The face box is dragged. In an example, by a touch screen, the user may contact any location on the face box except a vertex in a lower right corner, may move a contact point so that the label box may move with moving of the contact point. When the label box is moved to a suitable location, a contacting process is interrupted.

The face box is zoomed. In an example, through a touch screen, the user may contact a location on the vertex in the lower right corner, may move a contact point so that a size of the face box may be changed with moving of the contact point. When a suitable size of the face box may be obtained, the contact is interrupted.

The face box is deleted. In an example, through a touch screen, the user may continually touch any location in the face box until a deletion node arises, and may click the deletion node.

The edit operation above may be performed through operating a pointing device.

In an example, the client may further search for a user identifier of the user corresponding to the face region, and may display the user identifier of the user corresponding to the face region in the label box, and may push the image, the label box and the label information to the user corresponding to the user identifier. For example, when a face recognized from the face box is a face of a person naming “San Zhang” and the label information may be direct reviews information such as “handsome boy”, the user identifier (ID) of the “San Zhang” (e.g., an instant messaging code of the “San Zhang”) may be displayed in the label box, and the image, the label box and the label information may be pushed to the user (i.e., “San Zhang”) corresponding to the user identifier.

In another example, the client may further search for a user identifier of the user corresponding to the face region, and may display the user identifier of the user corresponding to the face region in the label box, and may push the image, the label box and the label information to at least one user in a friend relationship link of the user corresponding to the user identifier. For example, when a face recognized from the face box is a face of a person naming “San Zhang” and the label information may be direct reviews information such as “handsome boy” and friends of the user “San Zhang” include a user “Si Li” and a user “Wu Wang”, the user identifier (ID) of the user “San Zhang” (e.g., an instant messaging code of the user “San Zhang”) may be displayed in the label box, and the image, the label box and the label information may be pushed to the friends (i.e., the user “Si Li” and the user “Wu Wang”) of the user (i.e., “San Zhang”) corresponding to the user identifier.

In an example, the client uploads the image, the label box and the label information in the label box to the server. Thus, the server may search for the user identifier of the user corresponding to the face region according to the image, the label box and the label information in the label box, may display the user identifier of the user corresponding to the face region in the label noc, and may push the image, the label box and the label information to the user corresponding to the user identifier. For example, when a face recognized from the face box is a face of a person naming “San Zhang” and the label information may be direct reviews information such as “handsome boy”, the user identifier (ID) of the user “San Zhang” (e.g., an instant messaging code of the user “San Zhang”) may be displayed in the label box, and the image, the label box and the label information may be pushed to the user (i.e., “San Zhang”) corresponding to the user identifier.

In an example, the client uploads the image, the label box and the label information in the label box. Thus, the server may search for a user identifier of the user corresponding to the face region according to the image, the label box and the label information in the label box, and may display the user identifier of the user corresponding to the face region in the label box, and may push the image, the label box and the label information to at least one user in a friend relationship link of the user corresponding to the user identifier. For example, when a face recognized from the face box is a face of a person naming “San Zhang”, the label information may be direct reviews information such as “handsome boy”, and friends of the user “San Zhang” include a user “Si Li” and a user “Wu Wang”, the user identifier (ID) of the user “San Zhang” (e.g., an instant messaging code of the “San Zhang”) may be displayed in the label box, and the image, the label box and the label information may be pushed to the friends (i.e. the user “Si Li” and the user “Wu Wang”) of the user (i.e., “San Zhang”) corresponding to the user identifier.

An interactive method based on an image according to embodiments of the present invention may be applied to an application, in particular, to a particular application of “circle a person”.

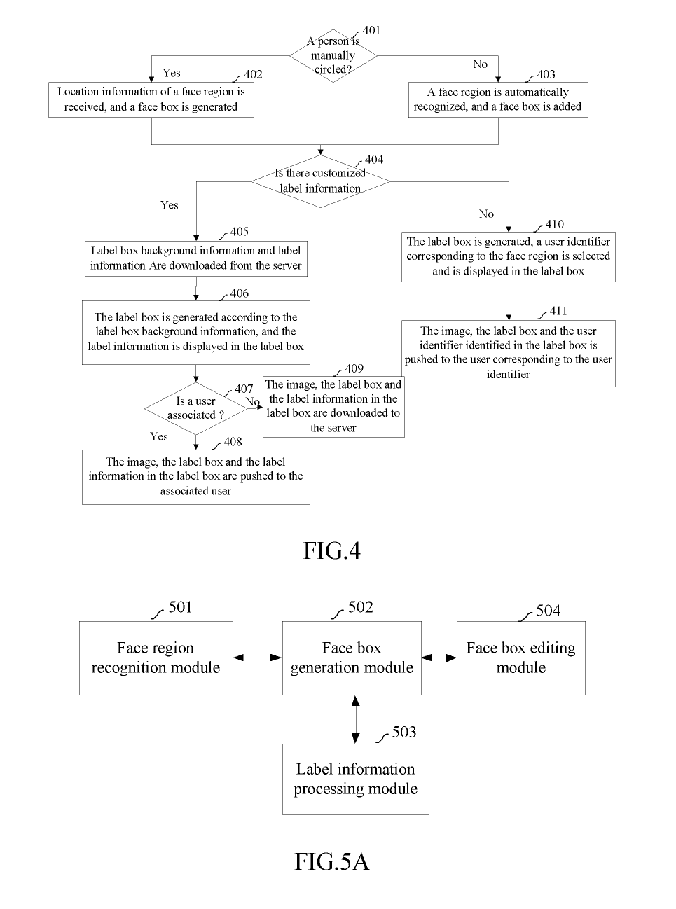

FIG. 4 is a flowchart illustrating a method for performing an application of “circle a person” based on an image according to an embodiment of the present invention.

As shown in FIG. 4, the method includes procedures as follows.

At block 401, the client determines whether a face region is manually detected and marked. When the face region is manually detected and marked, block 402 and next blocks are performed. When the face region is not manually detected and marked, block 403 and next blocks are performed. For an operation of manually “circle a person”, the client receives location information of the face region determined according to eyes.

At block 402, the client receives the location information of the face region determined according to the eyes. A face box is generated based on the location information of the face region, and then block 404 and next blocks are performed.

At block 403, the client automatically recognizes the face region by applying a face automatic recognition algorithm, and adds a face box, wherein the face box contains the recognized face region. In particular, the client may adopt a PCA, an ICA, an ISOMAP, a KPCA or a LPCA to automatically recognize the face region, and block 404 and next blocks are performed.

At block 404, the client determines whether there is customized label information. When there is the customized label information, block 405 and next blocks are performed. When there is not the customized label information, block 410 and next blocks are performed. In an example, the customized label information may be label information provided by a background of the server.

At block 405, the client downloads label box background information and label information from the server.

At block 406, the client generates the label box according to the label box background information, and displays the label information in the label box.

At block 407, the client determines whether the image, the label box and the label information in the label box is pushed to an associated user. When the image, the label box and the label information in the label box is pushed to the associated user, block 408 and next blocks are performed. When the image, the label box and the label information in the label box is not pushed to the associated user, block 409 and next blocks are performed. In an example, the associated user may be a user corresponding to the face region, and/or a user in a friend relationship link of the user corresponding to the face region.

At block 408, the client pushes the image, the label box and the label information in the label box to the associated user, and the process ends.

At block 409, the client uploads the image, the label box and the label information in the label box to the server, and the process ends.

At block 410, the client generates the label box, selects a user identifier corresponding to the face region and displays the user identifier in the label box.

At block 411, the client pushes the image, the label box and the user identifier identified in the label box to a client of the user corresponding to the user identifier.

Based on detail analysis above, an interactive apparatus based on an image is provided according to embodiment of the present invention.

FIG. 5A is a first schematic diagram illustrating a structure of an interactive apparatus based on an image according to an embodiment of the present invention. In an example, the entire apparatus may be located in a communication client. In an example, the communication client may be a computing device with a displaying function.

As shown in FIG. 5A, the apparatus includes a face region recognition module 501, a face box generation module 502 and a label information processing module 503.

The face region recognition module 501 is to recognize a face region in an image;

The face box generation module 502 is to generate a face box corresponding to the face region.

The label information processing module 503 is to generate a label box corresponding to the face box; represent label information corresponding to the face region in the label box by performing one of the following modes: obtaining the label information corresponding to the face region from a server, representing the label information obtained from the server in the label box; and receiving the label information corresponding to the face region inputted by a user, representing the label information inputted by the user in the label box.

In an example, the face region recognition module 501 is to recognize the face region in the image by applying a face automatic recognition algorithm. The face automatic recognition algorithm includes a Principal Component Analysis (PCA), an Independent Component Analysis (ICA), an Isometric Feature Mapping (ISOMAP), a Kernel Principal Components Analysis (KPCA), or a Linear Principal Component Analysis (LPCA) etc.

In an example, the apparatus further includes a face box editing module 504.

The face box editing module 504 is to perform at least one of the following editing operations for the face box generated by the face box generation module 502:
contacting, by the user, a location on the face box except a vertex in a lower right corner through a touch screen, moving a contact point to make the face move with moving of the contact point, interrupting contact operation when the face box is moved to a suitable location;
contacting, by the user, a location on the vertex in the lower right corner through a touch screen, moving a contact point to changing a size of the face box with the moving of the contact point, interrupting contact operation when a suitable size of the face box is obtained;
continually contacting, by the user, a location in the face box through a touch screen until a deletion node arises, clicking the deletion node to delete the face box.

The edit operation above may be performed through operating a pointing device.

In an example, the label information processing module 503 is to obtain label box background information from the server, generate the label box according to the label box background information, wherein the label box background information comprises a size of the label box, a representation way of the label box, and/or a color of the label box.

In an example, the label information processing module 503 is further to receive customized label information inputted by the user, represent the customized label information inputted by the user in the label box.

In an example, the label information processing module 503 is further to upload the image, the label box and the label information to the server.

FIG. 5B is a second schematic diagram illustrating a structure of an interactive apparatus based on an image according to an embodiment of the present invention. In an example, the entire apparatus may be located in a communication client. In an example, the communication client may be a computing device with a displaying function.

In the embodiment, except a face region recognition module 701, a face box generation module 702 and a label information processing module 703, a face box editing module 704, the apparatus further includes a label information pushing module 705, to search for the user identifier of the user corresponding to the face region, display the user identifier of the user corresponding to the face region in the label box, and push the image, the label box and the label information to the client of the user. For example, when a face recognized from the face box is a face of a person naming “San Zhang” and the label information may be direct reviews information such as “handsome boy”, the user identifier (ID) of the “San Zhang” (e.g., an instant messaging code of the “San Zhang”) may be displayed in the label box

The label information pushing module 705 is further to search for the user identifier of the user corresponding to the face region, display the user identifier of the user corresponding to the face region in the label box, and push the image, the label box and the label information to the client of a user in a relationship link of the user. For example, when a face recognized from the face box is a face of a person naming “San Zhang” and the label information may be direct reviews information such as “handsome boy” and friends of the user “San Zhang” include a user “Si Li” and a user “Wu Wang”, the user identifier (ID) of the user “San Zhang” (e.g., an instant messaging code of the user “San Zhang”) may be displayed in the label box.

Based on detail analysis above, a server is provided according to embodiment of the present invention.

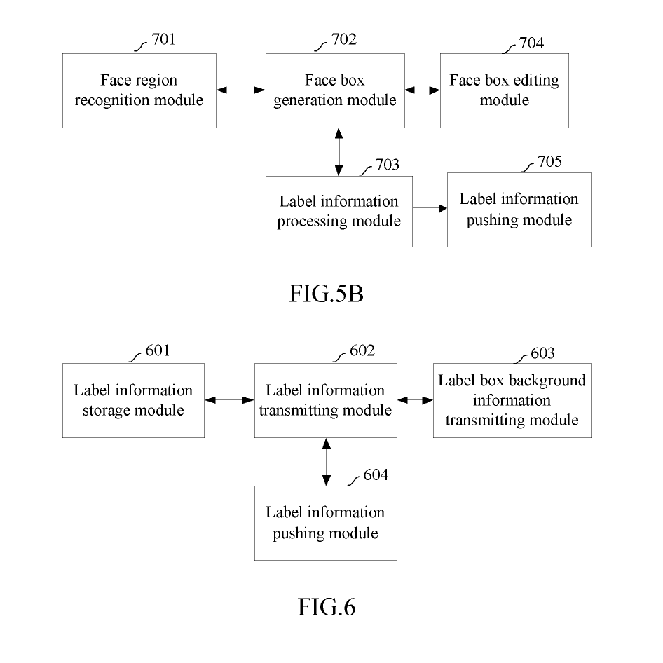

FIG. 6 is a schematic diagram illustrating a structure of a server according to an embodiment of the present invention. As shown in FIG. 6, the server includes a label information storage module 601 and a label information transmitting module 602.

The label information storage module 601 is to store pre-configured label information.

The label information transmitting module 602 is to transmit label information corresponding to a face region to a client so that the client represents the label information in a label box, wherein the face region is recognized from an image by the client, the label box corresponds to the face box of the face region.

In an example, the server further includes a label box background information transmitting module 603.

The label box background information transmitting module 603 is to provide label box background information to the client so that the client generates the label box according to the label box background information.

In an example, the server further includes a label information pushing module 604.

The label information pushing module 604 is receive the image, the label box and the label information in the label box uploaded from the client, search for a user identifier of a user corresponding to the face region, and push the image, the label box and the label information to the user corresponding to the user identifier. For example, when a face recognized from the face box is a face of a person naming “San Zhang” and the label information may be direct reviews information such as “handsome boy”, the user identifier (ID) of the “San Zhang” (e.g., an instant messaging code of the “San Zhang”) may be displayed in the label box

In an example, the label information pushing module 604 is receive the image, the label box and the label information in the label box uploaded from the client, search for a user identifier of a user corresponding to the face region, and push the image, the label box and the label information to a user in a relationship link of the user corresponding to the user identifier. For example, when a face recognized from the face box is a face of a person naming “San Zhang” and the label information may be direct reviews information such as “handsome boy” and friends of the user “San Zhang” include a user “Si Li” and a user “Wu Wang”, the user identifier (ID) of the user “San Zhang” (e.g., an instant messaging code of the user “San Zhang”) may be displayed in the label box.

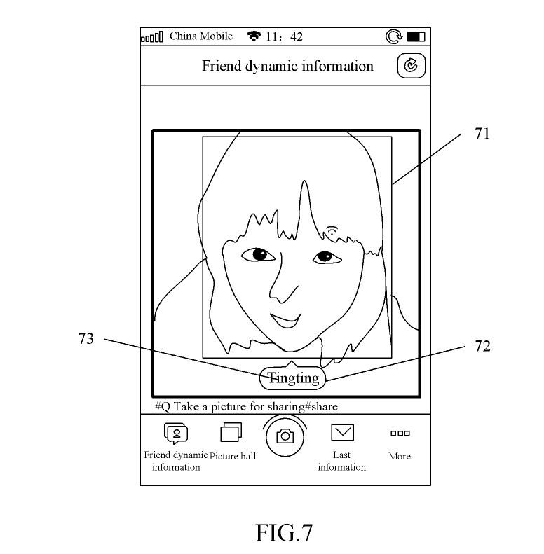

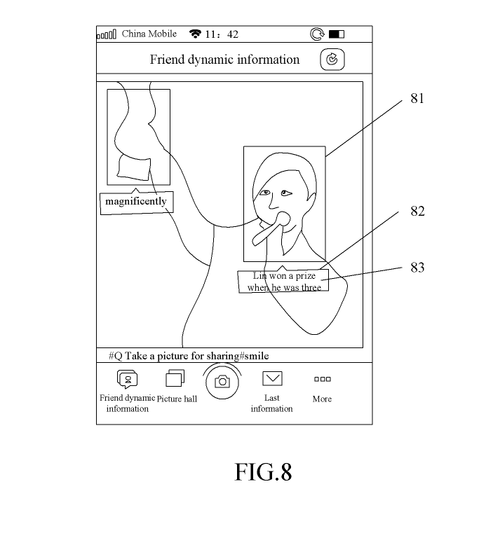

FIG. 7 is a first schematic diagram illustrating a way of displaying label information according to an embodiment of the present invention. In an image as shown in FIG. 7, label information 73 “Tingting” is represented in a label box 72 corresponding to a face box 71. The label information 73 is user name information corresponding to the face box 71. FIG. 8 is a second schematic diagram illustrating a way of displaying label information according to an embodiment of the present invention. In an image as shown in FIG. 8, label information 73 “Lin won a prize when he was three” is represented in a label box 72 corresponding to a face box 71.

For example, an image, a label box and label information are directly taken as feeds to be displayed, and a label is displayed according to configuration of a server. Thus, displaying is diversified, and more interesting by displaying the image, the label box and label information. Furthermore, friend information and label information in the image can be stored in a manner of assistant information when the user uploads the image. When a friend of the user logs on the server and accesses friend dynamic information, assistant information in the image is transmitted to the friend so that the label information can be displayed in the mobile terminal.

It can be seen from the above that those skilled in the art know that embodiments above can be implemented through software and necessary general hardware platform, or through hardware. In many conditions, the former is a preferable way. Based on understand above, the technical solution in essential according to the present invention, i.e., a part contributed to the prior art may be represented in a manner of a software product. The computer software product is stored in a storage medium, and includes instructions to make a computing device (e.g., a personal computer, a server or a network device) execute a method according to each embodiment above.

It can be understood by those skilled in the art that modules in the apparatus according to an embodiment above of the present invention can be located in an apparatus as described according to the embodiment of the present invention, or can be changed to be located in one or more apparatuses different from that in the embodiment of the present invention. The modules can combined to one module, or can be separated into multiple sub-modules.

It can be seen from the above that, in an embodiment of the present invention, a face region is recognized in an image, a face box is generated corresponding to the face region, and label information corresponding to the face region is represented in the label box by performing one of the following modes: obtaining the label information associated with the face region from a server, representing the label information obtained from the server in the label box; and receiving the label information corresponding to the face region inputted by a user, representing the label information inputted by the user in the label box. Thus, after applying the technology solution according to the present invention, information associated with the circled region can be customized (e.g., reviews information), and can be further pushed to an associated friend. Thus, interaction between a user pushing the face region and the associated friend is improved.

The foregoing is only preferred examples of the present invention and is not used to limit the protection scope of the present invention. Any modification, equivalent substitution and improvement without departing from the spirit and principle of the present invention are within the protection scope of the present invention.

1. An interactive method based on an image, comprising:
recognizing a face region in an image;
generating a face box corresponding to the face region;
generating a label box corresponding to the face box; and
representing label information corresponding to the face region in the label box by performing one of the following modes: obtaining the label information corresponding to the face region from a server, representing the label information obtained from the server in the label box; and
receiving the label information corresponding to the face region inputted by a user, representing the label information inputted by the user in the label box.

2. The method of claim 1, wherein the face region is recognized by performing one of the following algorithms:
a Principal Component Analysis (PCA), an Independent Component Analysis (ICA), an Isometric Feature Mapping (ISOMAP), a Kernel Principal Components Analysis (KPCA), a Linear Principal Component Analysis (LPCA).

3. The method of claim 1, further comprising:
performing at least one of the following editing operations for the face box:
when a location on the face box except a vertex in a lower right corner is moved, moving the face box with moving of a contact point so that the face box is moved to a suitable location;
when a location on the vertex in the lower right corner is contacted, changing a size of the face box with the moving of a contact point so that a suitable size of the face box is obtained;
when a deletion node is clicked deleting the face box.

4. The method of claim 1, wherein generating the label box corresponding to the label box comprises:
obtaining label box background information from the server;
generating the label box according to the label box background information, wherein
the label box background information comprises at least one of a size of the label box, a representation way of the label box and a color of the label box.

5. The method of claim 1, further comprising:
calculating, by the server, pre-configured frequency of using at least one candidate word of the label information;
ranking the at least one candidate word of the label information based on the frequency of using the at least one candidate word from biggest to smallest to obtain a ranking result;
generating a label information list according to the ranking result, wherein the number of at least one candidate word in the label information list is predetermined.
the process of obtaining the label information corresponding to the face region from a server, representing the label information obtained from the server in the label box comprises:
obtaining the label information list from the server;
obtaining the at least one candidate word from the label information list;
selecting at least one candidate word corresponding to the face region from the at least one candidate word in the label information list; and
displaying the at least one candidate word corresponding to the face region in the label box.

6. The method of claim 1, further comprising:
searching for a user identifier of the user corresponding to the face region;
displaying the user identifier of the user corresponding to the face region in the label box;
pushing the image, the label box and the label information to the user and/or a user in a relationship link of the user.

7. The method of claim 1, further comprising:
uploading the image, the label box and the label information to the server so that the server searches for the user identifier of the user corresponding to the face region;
displaying the user identifier of the user corresponding to the face region in the label box;
pushing the image, the label box and the label information to the user and/or a user in a relationship link of the user.

8. An interactive apparatus based on an image, comprising:
a face region recognition module, to recognize a face region in an image;
a face box generation module, to generate a face box corresponding to the face region;
a label information processing module, to generate a label box corresponding to the face box; represent label information corresponding to the face region in the label box by performing one of the following modes:
obtaining the label information corresponding to the face region from a server, representing the label information obtained from the server in the label box; and receiving the label information corresponding to the face region inputted by a user, representing the label information inputted by the user in the label box.

9. The apparatus of claim 8, wherein the face region is recognized by performing one of the following algorithms:
a Principal Component Analysis (PCA), an Independent Component Analysis (ICA), an Isometric Feature Mapping (ISOMAP), a Kernel Principal Components Analysis (KPCA), a Linear Principal Component Analysis (LPCA).

10. The apparatus of claim 8, further comprising:
a face box editing module, to perform at least one of the following editing operations for the face box:
when a location on the face box except a vertex in a lower right corner is moved, moving the face box with moving of a contact point so that the face box is moved to a suitable location;
when a location on the vertex in the lower right corner is contacted changing a size of the face box with the moving of a contact point so that a suitable size of the face box is obtained;
when a deletion node is clicked, deleting the face box.

11. The apparatus of claim 8, wherein the label information processing module is to obtain label box background information from the server, generate the label box according to the label box background information, wherein the label box background information comprises at least one of a size of the label box, a representation way of the label box and a color of the label box.

12. The apparatus of claim 8, wherein the label information processing module is further to upload the image, the label box and the label information to the server so that the server searches for the user identifier of the user corresponding to the face region, display the user identifier of the user corresponding to the face region in the label box, push the image, the label box and the label information to the user and/or a user in a relationship link of the user.

13. The apparatus of claim 8, further comprising:
a label information pushing module, to search for the user identifier of the user corresponding to the face region, display the user identifier of the user corresponding to the face region in the label box, and push the image, the label box and the label information to the user and/or a user in a relationship link of the user.

14. A server, comprising:
a label information storage module, to store pre-configured label information;
a label information transmitting module, to transmit label information corresponding to a face region to a client so that the client represents the label information in a label box, wherein the face region is recognized from an image by the client, the label box corresponds to the face box of the face region.

15. The server of claim 14, further comprising:
a label box background information transmitting module, to provide label box background information to the client so that the client generates the label box according to the label box background information.

16. The server of claim 4, wherein the label box background information transmitting module is further to receive the image, the label box and the label information in the label box uploaded from the client.

17. The server of claim 16, further comprising:
a label information pushing module, to search for a user identifier of a user corresponding to the face region, and push the image, the label box and the label information to the user corresponding to the user identifier.

18. The server of claim 16, further comprising:
a label information pushing module, to search for a user identifier of a user corresponding to the face region, and push the image, the label box and the label information to a user in a relationship link of the user corresponding to the user identifier.

19. The server of claim 14, wherein the label information storage module is further to calculate pre-configured frequency of using at least one candidate word of the label information; rank the at least one candidate word of the label information based on the frequency of using the at least one candidate word from biggest to smallest to obtain a ranking generate a label information list according to the ranking result, wherein the number of at least one candidate word in the label information list is predetermined.
